(19) United States
(12) Patent Application Publication
(10) Pub. No.: US 2008/0317535 A1
(43) Pub. Date: Dec. 25, 2008

(54) Image forming apparatus, image forming system, and control method therefor

(75) Inventor: Yuuko Shimizu, Tokyo (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/213,501

(22) Filed: Jun. 20, 2008

(30) Foreign Application Priority Data
Jun. 20, 2007 (JP) 2007-162500

(51) Int. Cl. G03G 15/00

(52) U.S. Cl. 399/405

(57) ABSTRACT

An image forming apparatus, an image forming system, and a control method therefor. The image forming apparatus includes at least one tray, a manual feed tray, a setting unit to set the at least one tray and the manual feed tray to be out of search, an acquiring unit to acquire tray information of the at least one tray when the at least one tray is set to be subject to the search and of the manual feed tray irrespective of whether the manual feed tray is set to be out of search upon receipt of an acquisition request from a request source, and a reporting unit to report the tray information to the request source.

### CROSS-REFERENCE TO RELATED APPLICATION

This patent specification is based on and claims priority from Japanese Patent Application No. 2007-162500, filed on Jun. 20, 2007 in the Japan Patent Office, the entire contents of which are hereby incorporated by reference herein.

### BACKGROUND

1. Field of the Invention

The present invention relates to an image forming apparatus, an image forming system, and a control method therefor.

2. Description of the Related Art

As automation and networking rapidly spread in offices, a variety of equipment is connected via networks to share the equipment and to speed up processing.

For example, an information processing apparatus such as a personal computer is connected to an image forming apparatus such as a printer via a network to increase processing efficiency.

However, when a user of the information processing apparatus cannot know an immediate status of the image forming apparatus, print requests sent to the image forming apparatus are often not processed, for example, due to a shortage of image forming media, or sheets.

This problem is solved by a printing system in which the information processing apparatus acquires information of sheet feed trays of the image forming apparatus so that a sheet is fed from a suitable tray based on the acquired tray information, thereby achieving greater processing efficiency.

In such a printing system, the user can set a specific tray containing special sheets of paper to be out of search by turning on a tray lock so that the special sheet is not fed from the tray when another user uses the same printer (image forming apparatus) without specifying a tray. Being an out-of-search tray as used herein means that the information of the tray is not searched for during acquisition of the tray information.

However, when a manual feed tray is installed in the image forming apparatus and set to be out of search (i.e., the tray lock for the manual feed tray is on), an error occurs during acquisition of the tray information and the tray information thereof cannot be acquired.

Therefore, it is necessary to develop a control method to prevent the above-described error from occurring during acquisition of the tray information and acquire the tray information of the manual feed tray irrespective of whether or not the manual feed tray is set to be out of search.

### SUMMARY

This patent specification describes a novel image forming apparatus that includes at least one tray and a manual feed tray, a setting unit to set the at least one tray and the manual feed tray to be out of search, an acquiring unit to acquire tray information of the at least one tray when the at least one tray is set to be subject to the search and of the manual feed tray irrespective of whether the manual feed tray is set to be out of search upon receipt of an acquisition request from a request source, and a reporting unit to report the tray information to the request source.

This patent specification further describes a novel image forming system including an information processing apparatus and an image forming apparatus having at least one tray and a manual feed tray installed therein. The information processing apparatus reports an acquisition request to the image forming apparatus to acquire tray information. The image forming apparatus includes a setting unit to set the at least one tray and the manual feed tray to be out of search, an acquiring unit to acquire tray information of the at least one tray when the at least one tray is set to be subject to the search and of the manual feed tray irrespective of whether the manual feed tray is set to be out of search upon receipt of the acquisition request from the information processing apparatus, and a reporting unit to report the tray information to the information processing apparatus.

This patent specification further describes a novel control method for an image forming apparatus comprising at least one tray and a manual feed tray installed therein. The control method includes selecting whether or not to set the at least one tray and the manual feed tray to be out of search, acquiring tray information of the at least one tray when the at least one tray is set to be subject to the search and of the manual feed tray irrespective of whether the manual feed tray is set to be out of search upon receipt of an acquisition request from a request source, and reporting the tray information to the request source.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating example configurations of an image forming system and an image forming apparatus according to a first embodiment of the present invention;

FIG. 2 is a diagram illustrating an example configuration of a tray lock holding area of the image forming apparatus of FIG. 1;

FIG. 3 is a diagram illustrating an example configuration of a subject-device tray information holding area of the image forming apparatus of FIG. 1;

FIG. 4 is a diagram illustrating an example configuration of a tray priority order holding area of the image forming apparatus of FIG. 1;

FIG. 5 is a flowchart illustrating an example tray search process performed in the image forming apparatus according to the first embodiment of the present invention;

FIG. 6 is a diagram illustrating an example configuration of the subject-device tray information holding area of the image forming apparatus of FIG. 1 when trays are not appropriately installed;

FIG. 7 is a diagram illustrating an example configuration of the tray priority order holding area of the image forming apparatus of FIG. 1 when the trays are not appropriately installed;

FIG. 8 is a flowchart illustrating an example tray information acquisition process performed in the image forming apparatus according to the first embodiment of the present invention;

FIG. 9 is a flowchart illustrating an example tray information acquisition process performed in an image forming apparatus according to a second embodiment of the present invention; and

FIG. 10 is a flowchart illustrating an example process when a user specifies a sheet feed tray based on tray information according to a third embodiment of the present invention.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve a similar result.

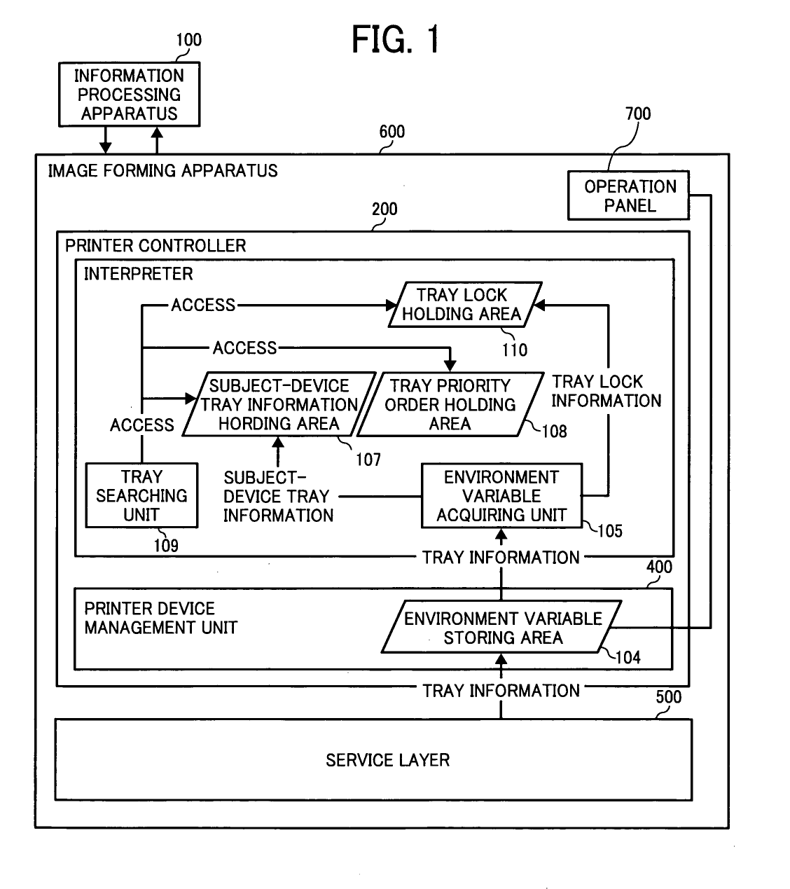

Referring now to the drawings, wherein like reference numerals designate identical or corresponding parts throughout the several views thereof, particularly to FIG. 1, image forming apparatuses according to exemplary embodiments of the present invention are described.

An image forming system according to a first embodiment of the present invention is described with reference to FIG. 1.

As illustrated in FIG. 1, the image forming system according to the first embodiment includes an information processing apparatus 100 (a request source) and an image forming apparatus 600 with trays, not shown, installed therein. The trays include pullout trays and a manual feed tray.

The information processing apparatus 100 reports an acquisition request to the image forming apparatus 600 to acquire the tray information of the trays, such as sheet size and sheet type.

When receiving the acquisition request, the image forming apparatus 600 acquires the tray information of the trays installed therein and reports the acquired tray information to the information processing apparatus 100.

The image forming apparatus 600 according to the first embodiment includes an operation panel 700 serving as a setting unit that sets a tray to be out of search so that the tray information of the tray is not searched for, i.e., not acquired. The image forming apparatus 600 acquires the tray information of the manual feed tray installed therein irrespective of whether or not the manual feed tray is set to be out of search.

Specifically, the image forming apparatus 600 acquires the tray information of the manual feed tray when the tray information of the trays except the manual feed tray is null.

When the manual feed tray is set to be out of search, the image forming apparatus 600 cancels the out-of-search setting thereof and acquires the tray information of the manual feed tray.

Therefore, the image forming system according to the first embodiment is able to prevent an error from occurring during acquisition of the tray information.

The image forming system according to the first embodiment is now described in detail with reference to the drawings.

The configuration of the image forming system according to the first embodiment is described with reference to FIG. 1.

The image forming system according to the first embodiment is constructed by connecting the information processing apparatus 100 to the image forming apparatus 600 via a network as illustrated in FIG. 1.

The network for constructing the image forming system according to the first embodiment is not limited to any particular network. Accordingly, all types of networks, either wired or wireless, are available as long as information is communicated between the information processing apparatus 100 and the image forming apparatus 600.

The configuration of the image forming apparatus 600 according to the first embodiment is described with reference to FIG. 1.

The image forming apparatus 600 according to the first embodiment includes a printer controller 200, a service layer 500, and the operation panel 700.

The printer controller 200 controls printing in the image forming apparatus 600, and includes an interpreter 300 and a printer device management unit 400.

A user enters settings regarding the image forming apparatus 600 from the operation panel 700. The setting information entered from the operation panel 700 is stored in an environment variable storing area 104 included in the printer device management unit 400.

The interpreter 300 analyzes and renders print job data sent from the information processing apparatus 100 and sends a control command for a printing device and rendering data to the printer device management unit 400.

When receiving the control command for the printing device and the rendering data from the interpreter 300, the printer device management unit 400 sends the control command for the printing device and the rendering data to the service layer 500 and performs printing.

The printer device management unit 400 acquires subject-device tray information and tray lock information from the service layer 500 and stores the acquired information in the environment variable storing area 104.

An environment variable acquiring unit 105 included in the interpreter 300 acquires the subject-device tray information and the tray lock information from the environment variable storing area 104. The environment variable acquiring unit 105 sets the acquired subject-device tray information in a subject-device tray information holding area 107 and sets the acquired tray lock information in a tray lock holding area 110.

A tray priority order holding area 108 included in the interpreter 300 manages tray priority information generated based on an order of priority of trays that is predetermined for each device.

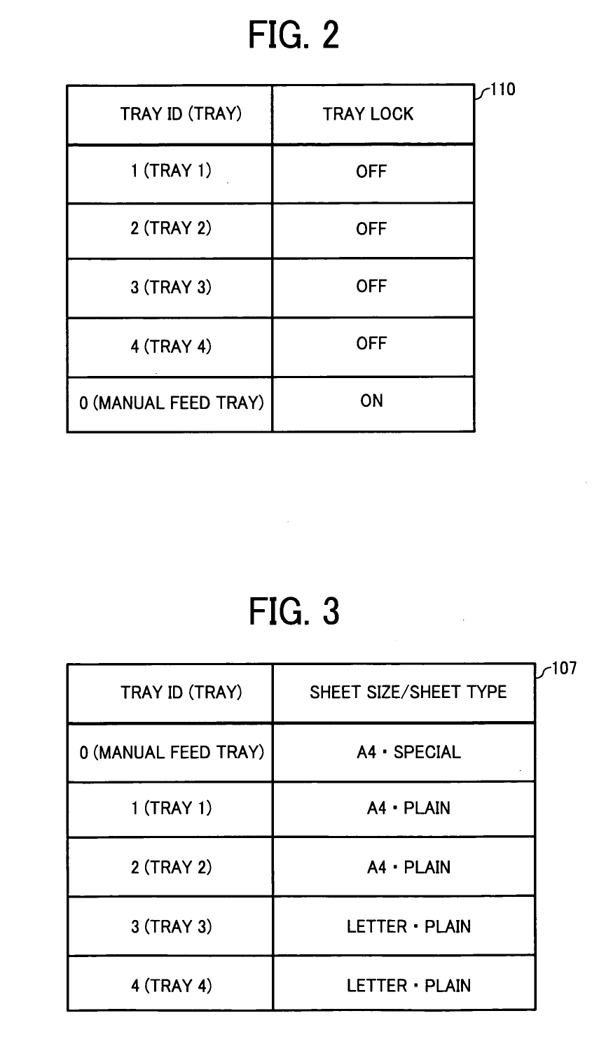

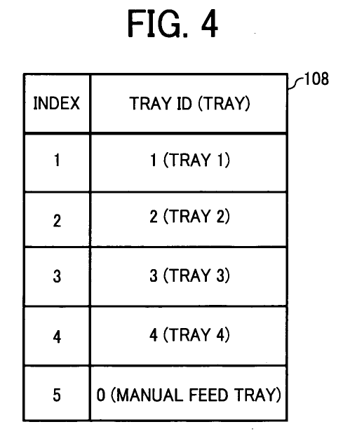

FIGS. 2, 3, and 4 illustrate the contents of the holding areas 110, 107, and 108, respectively, when the trays installed in the image forming apparatus 600 are under the following tray conditions. FIG. 2 illustrates the tray lock holding area 110, FIG. 3 illustrates the subject-device tray information holding area 107, and FIG. 4 illustrates the tray priority order holding area 108. Trays 1 to 4 are the pull-out trays having tray IDs of 1 to 4 and the manual feed tray has a tray ID of 0.

<Tray conditions>

| Tray type | Sheet size/Sheet type | Tray lock |
|---|---|---|
| Manual feed tray | A4/Special | On |
| Tray 1 | A4/Plain | Off |
| Tray 2 | A4/Plain | Off |
| Tray 3 | Letter/Plain | Off |
| Tray 4 | Letter/Plain | Off |

The order of priority is Tray 1, Tray 2, Tray 3, Tray 4, and Manual feed tray as indicated by indexes 1 to 5 shown in FIG. 4.

A tray searching unit 109 included in the interpreter 300 serves as an acquiring unit and a reporting unit. The tray searching unit 109 accesses the subject-device tray information holding area 107, the tray priority order holding area 108, and the tray lock holding area 110, acquires the tray information, and reports the acquired tray information to the information processing apparatus 100.

The user is able to send a print job to the image forming apparatus 600 and acquire the tray information from the image forming apparatus 600 by using a driver or a command prompt installed on the information processing apparatus 100. Specifically, an acquisition request to acquire the tray information is reported from the information processing apparatus 100 to the image forming apparatus 600 by sending a request command to the image forming apparatus 600 using a communication command at, for example, a command prompt installed on the information processing apparatus 100. The image forming apparatus 600 analyzes the received request command at the interpreter 300, acquires data in the subject-device tray information holding area 107, and sends the data to the command prompt via the network.

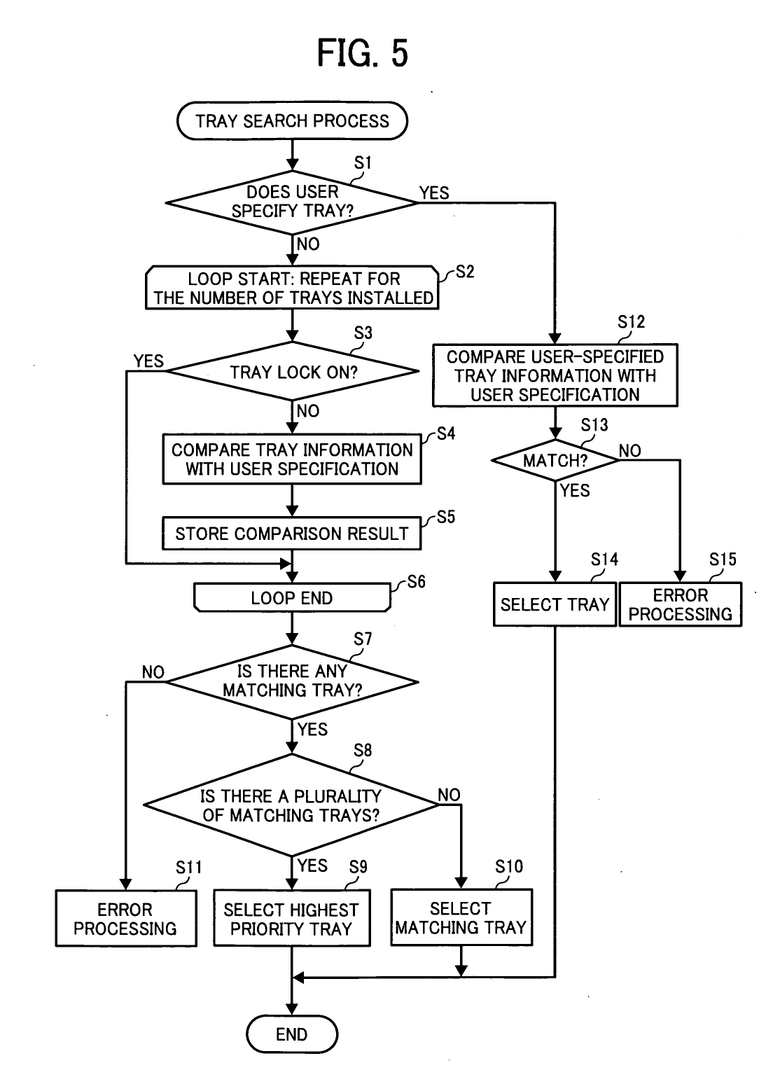

A tray search process according to the first embodiment of the present invention is now described with reference to FIG. 5. FIG. 5 is a flowchart illustrating the tray search process according to the first embodiment.

The tray search process refers to accessing the subject-device tray information holding area 107 by the tray searching unit 109, comparing user-specified sheet feed information (sheet size, sheet type, and tray number) with the tray information (sheet size, sheet type, and tray number) in the subject-device tray information holding area 107, and determining a sheet feed tray for use in printing.

Through the tray search process, the user is able to determine a sheet feed tray for use in printing performed by the image forming apparatus 600 upon transmission of print data from the information processing apparatus 100 to the image forming apparatus 600.

The tray searching unit 109 is able to access the subject-device tray information holding area 107 and acquire the tray information by using a command written in a printer language, independently of the printing process.

The tray searching unit 109 determines whether or not the user has specified a tray (tray number) in the print job (step S1). When determining that the user has specified a tray (tray number) in the print job (step S1/Yes), the tray searching unit 109 compares the subject-device tray information (sheet size and sheet type) of the tray (tray number) specified by the user in the print job and the information (sheet size and sheet type) specified by the user in the print job (step S12).

When determining that the subject-device tray information matches the specified information (step S13/Yes), the tray searching unit 109 selects the matching tray (step S14), and processing ends.

When determining that the subject-device tray information does not match the specified information (step S13/No), the tray searching unit 109 performs error processing (step S15).

The error processing described herein includes processing such as reporting of occurrence of an error (reporting that there is no tray matching the user specification specified in the print job) to the user of the information processing apparatus 100.

When determining that the user has not specified a tray (tray number) in the print job (step S1/No), the tray searching unit 109 repeats the processing from step S3 to step S5 for the number of trays installed in the image forming apparatus 600 (step S2: loop start).

For each of the trays installed in the image forming apparatus 600, the tray searching unit 109 determines whether or not the tray is set to be but of search, i.e., whether or not the tray lock is on (see FIG. 2) (step S3). The tray searching unit 109 proceeds to step S4 and step S5 when determining that the tray lock for the tray is off.

When determining that the tray lock for the tray is off (step S3/No), the tray searching unit 109 compares the subject-device tray information (sheet size and sheet type) of the tray (see FIG. 3) with the information (sheet size and sheet type) specified by the user in the print job (step S4) and stores the comparison result in a memory (step S5).

After the tray searching unit 109 repeats the processing from step S3 to step S5 for the number of trays installed in the image forming apparatus 600 (step S6: loop end), the tray searching unit 109 determines if there is a matching tray having the subject-device tray information (sheet size and sheet type) that matches the user-specified information (sheet size and sheet type) based on the comparison result stored in the memory at step S5 (step S7).

When the tray searching unit 109 determines that there is a matching tray (step S7/Yes), the tray searching unit 109 determines if there is a plurality of matching trays (step S8).

When determining that there is a plurality of matching trays (step S8/Yes), the tray searching unit 109 selects a highest priority tray (see FIG. 4) from the plurality of matching trays (step S9), and the processing ends.

When determining that there is not a plurality of matching trays (step S8/No), the tray searching unit 109 selects the matching tray (step S10), and the processing ends.

When determining that there is no matching tray (step S7/No), the tray searching unit 109 performs error processing (step S11).

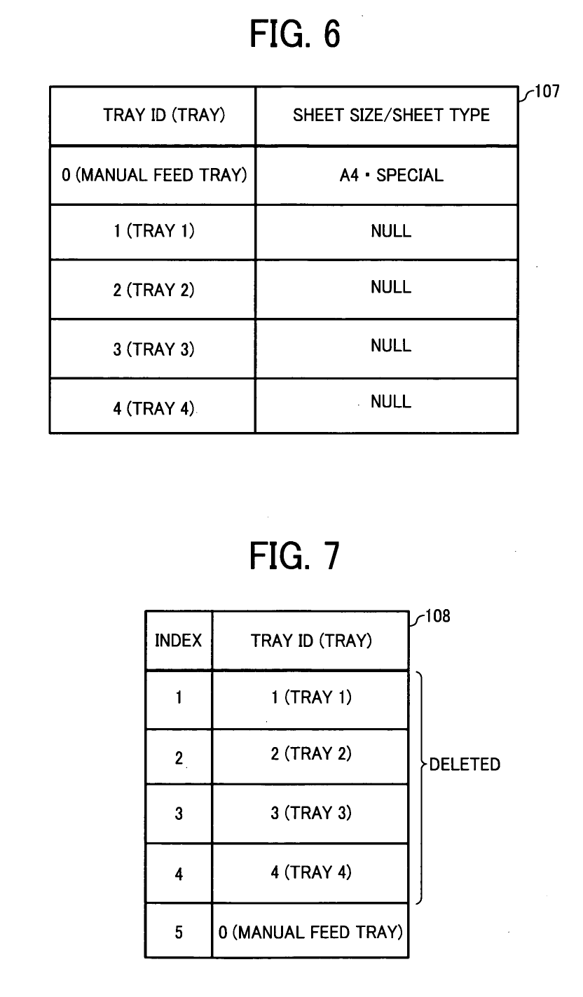

When starting the image forming apparatus 600 in a state in which the pullout trays, i.e., the trays except the manual feed tray, are not appropriately installed in the image forming apparatus 600, the subject-device tray information holding area 107 and the tray priority order holding area 108 are as illustrated in FIGS. 6 and 7, respectively. FIG. 6 illustrates the contents of the subject-device tray information holding area 107 and FIG. 7 illustrates the contents of the tray priority order holding area 108.

As illustrated in FIG. 6, the information of the trays except the manual feed tray (i.e. Trays 1 to 4) is null in the subject-device tray information holding area 107 since the pullout trays (Trays 1 to 4) are not appropriately installed in the image forming apparatus 600, and therefore the environment variable acquiring unit 105 is unable to acquire the information of the pullout trays (Trays 1 to 4).

Also, as illustrated in FIG. 7, the information of the trays except the manual feed tray (i.e. Trays 1 to 4) is deleted from the tray priority order holding area 108 since the pullout trays (Trays 1 to 4) are not appropriately installed in the image forming apparatus 600 and therefore the environment variable acquiring unit 105 is unable to acquire the information of the pullout trays (Trays 1 to 4).

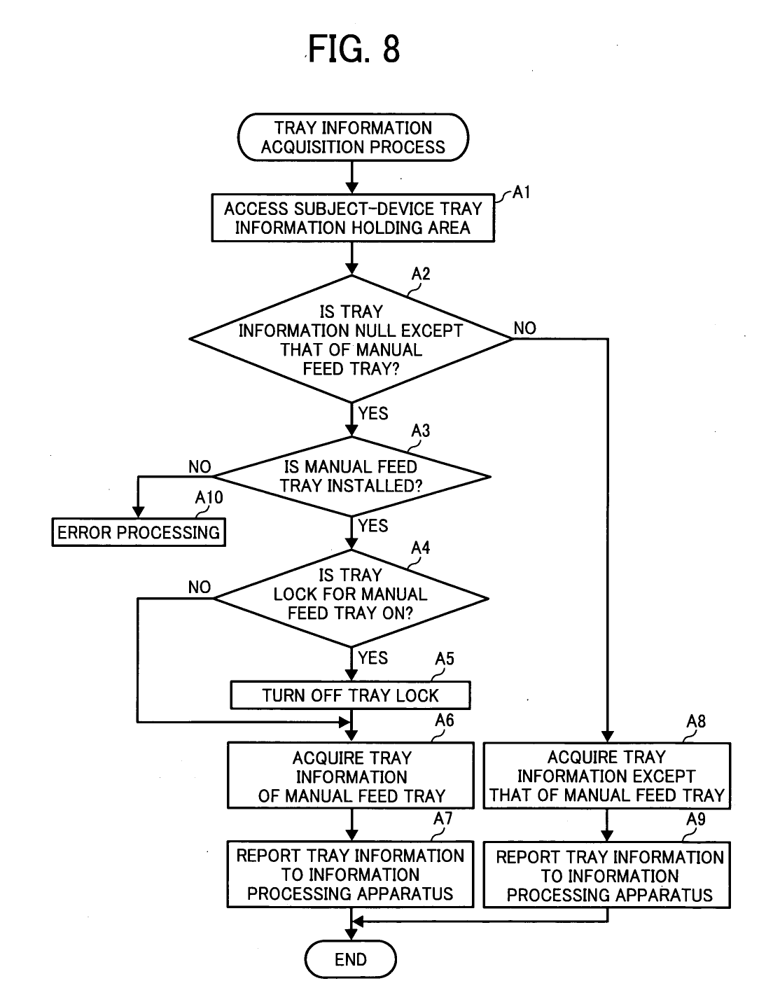

A method of acquiring the tray information according to the first embodiment is now described with reference to FIG. 8.

The tray searching unit 109 accesses the subject-device tray information holding area 107 (step A1) and determines whether or not the tray information except that of the manual feed tray is null (step A2).

When the tray searching unit 109 determines that the tray information except that of the manual feed tray is null (step A2/Yes), the tray searching unit 109 determines whether or not the manual feed tray is installed in the image forming apparatus 600 (step A3).

When determining that the manual feed tray is installed in the image forming apparatus 600 (step A3/Yes), the tray searching unit 109 determines whether or not the manual feed tray is set to be out of search (whether or not the tray lock for the manual feed tray is on) (step A4).

When determining that the manual feed tray is set to be out of search (the tray lock for the manual feed tray is on) (step A4/Yes), the tray searching unit 109 cancels the out-of-search setting of the manual feed tray (turns off the tray lock for the manual feed tray) (step A5) and acquires the tray information of the manual feed tray (step A6) The tray searching unit 109 then reports the tray information of the manual feed tray to the information processing apparatus 100 (step A7).

When determining that the manual feed tray is not set to be out of search (the tray lock is off) (step A4/No), the tray searching unit 109 acquires the tray information of the manual feed tray (step A6) and reports the acquired tray information to the information processing apparatus 100 (step A7).

When determining that the manual feed tray is not installed in the image forming apparatus 600 (step A3/No), the tray searching unit 109 performs error processing (step A10).

The error processing includes processing such as reporting of occurrence of an error (a failure to acquire the tray information) to the user of the information processing apparatus 100.

When determining that the tray information except that of the manual feed tray is not null (step A2/No), the tray searching unit 109 acquires the tray information except that of the manual feed tray (step A8) and reports the acquired tray information to the information processing apparatus 100 (step A9).

As described above, in the image forming apparatus 600 according to the first embodiment, when the tray information except that of the manual feed tray is null (step A2/Yes) and the manual feed tray is set to be out of search (the tray lock for the manual feed tray is on) (step A4/Yes), the tray searching unit 109 cancels the out-of-search setting of the manual feed tray (step A5) and acquires the tray information of the manual feed tray (step A6).

Therefore, the image forming apparatus 600 according to the first embodiment is able to acquire the tray information of the manual feed tray and report the acquired tray information to the information processing apparatus 100 irrespective of whether or not the manual feed tray is set to be out of search (irrespective of whether the tray lock for the manual feed tray is on).

Accordingly, the user of the information processing apparatus 100 is able to know the sheet size and the sheet type of the sheets placed in the manual feed tray based on the tray information acquired from the image forming apparatus 600 even when the manual feed tray is set to be out of search (the tray lock for the manual feed tray is on). The user who checks the tray information and wants to use the manual feed tray is thus able to specify the manual feed tray as a sheet feed tray and perform printing by the image forming apparatus 600.

A second embodiment of the present invention is now described.

In the image forming apparatus 600 according to the first embodiment, when determining that the tray information except that of the manual feed tray is null (step A2/Yes), the tray searching unit 109 determines whether or not the manual feed tray is set to be out of search (whether or not the tray lock for the manual feed tray is on) (step A4) as illustrated in FIG. 8. Then, when the manual feed tray is set to be out of search (the tray lock for the manual feed tray is on) (step A4/Yes), the tray searching unit 109 cancels the out-of-search setting of the manual feed tray (step A5) and acquires the tray information of the manual feed tray (step A6).

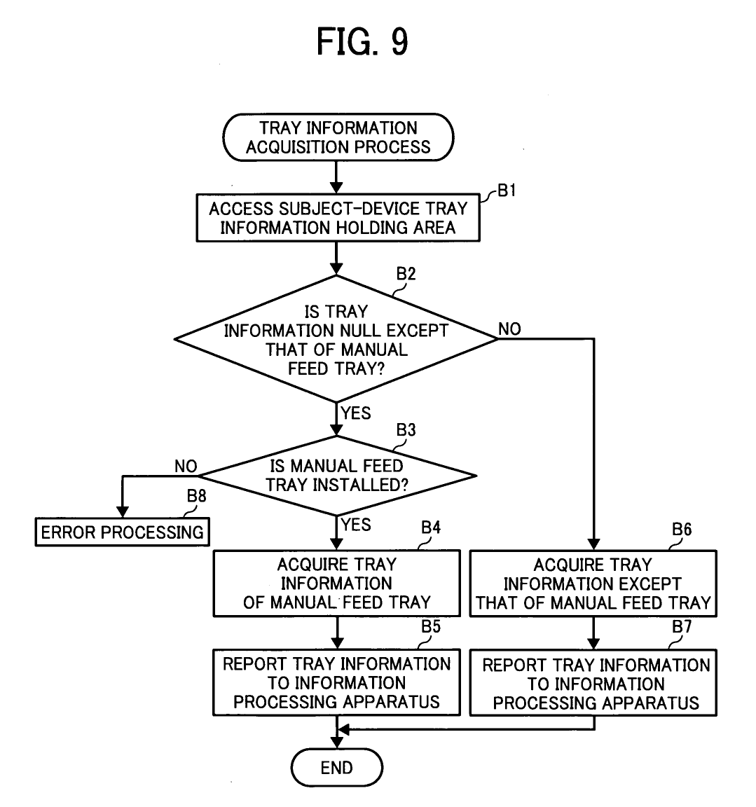

In the image forming apparatus 600 according to the second embodiment, when determining that the tray information except that of the manual feed tray is null (step B2/Yes), the tray searching unit 109 acquires the tray information of the manual feed tray without determining whether or not the manual feed tray is set to be out of search (whether or not the tray lock for the manual feed tray is on) (step B4) as illustrated in FIG. 9.

Therefore, the second embodiment allows simpler acquisition of the tray information of the manual feed tray and reporting of the acquired tray information to the information processing apparatus 100.

The configuration and operation of the image forming apparatus 600 according to the second embodiment are now described in detail with reference to FIG. 9.

The configuration of the image forming apparatus 600 according to the second embodiment is the same as that according to the first embodiment.

As for a method of acquiring the tray information according to the second embodiment, the tray searching unit 109 accesses the subject-device tray information holding area 107 (step B1) and determines whether or not the tray information except that of the manual feed tray is null (step B2).

When the tray searching unit 109 determines that the tray information except that of the manual feed tray is null (step B2/Yes), the tray searching unit 109 determines whether or not the manual feed tray is installed in the image forming apparatus 600 (step B3).

When determining that the manual feed tray is installed in the image forming apparatus 600 (step B3/Yes), the tray searching unit 109 acquires the tray information of the manual feed tray irrespective of whether or not the manual feed tray is set to be out of search (irrespective of whether the tray lock for the manual feed tray is on) (step B4). The tray searching unit 109 reports the tray information of the manual feed tray to the information processing apparatus 100 (step B5).

When determining that the tray information except that of the manual feed tray is not null (step B2/No), the tray searching unit 109 acquires the tray information except that of the manual feed tray (step B6) and reports the acquired tray information to the information processing apparatus 100 (step B7).

When determining that the manual feed tray is not installed in the image forming apparatus 600 (step B3/No), the tray searching unit 109 performs error processing (step B8).

The error processing includes processing such as reporting of occurrence of an error (a failure to acquire the tray information) to the user of the information processing apparatus 100.

As described above, the image forming apparatus 600 according to the second embodiment is able to acquire the tray information of the manual feed tray and report the acquired tray information to the information processing apparatus 100 irrespective of whether or not the manual feed tray is set to be out of search (irrespective of whether the tray lock for the manual feed tray is on).

Therefore, the user of the information processing apparatus 100 is able to know the sheet size and the sheet type of the sheets placed in the manual feed tray based on the tray information acquired from the image forming apparatus 600 even when the manual feed tray is set to be out of search (the tray lock for the manual feed tray is on). The user who checks the tray information and wants to use the manual feed tray is thus able to specify the manual feed tray as a sheet feed tray and perform printing by the image forming apparatus 600.

Also, in the image forming apparatus 600 according to the second embodiment, when determining that the tray information except that of the manual feed tray is null, the tray searching unit 109 acquires the tray information of the manual feed tray without determining whether or not the manual feed tray is set to be out of search (whether or not the tray lock for the manual feed tray is on).

Therefore, the image forming apparatus 600 according to the second embodiment is able to acquire the tray information of the manual feed tray and report the acquired tray information to the information processing apparatus 100 more simply.

A third embodiment of the present invention is now described.

In the third embodiment, the user of the information processing apparatus 100 specifies a sheet feed tray based on the tray information reported to the user as in the above-described first and second embodiments and performs printing using the image forming apparatus 600.

When receiving a print request from the information processing apparatus 100, the image forming apparatus 600 is able to perform printing using a user-specified tray irrespective of whether or not the tray is set to be out of search.

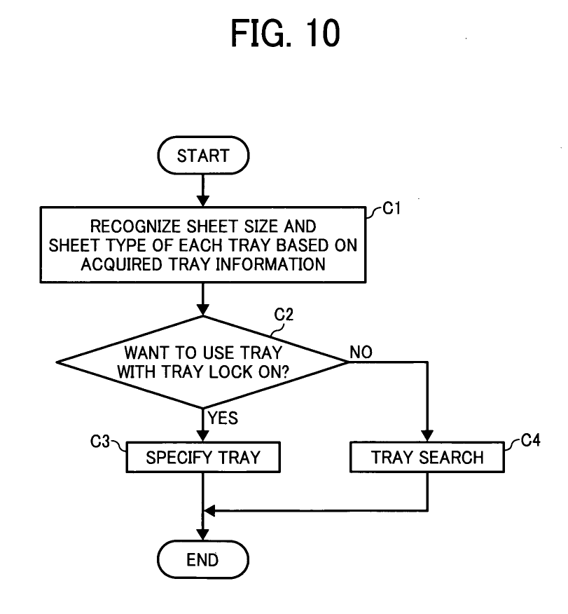

The configuration and operation of the image forming apparatus 600 according to the third embodiment are now described in detail with reference to FIG. 10.

The configuration of the image forming apparatus 600 according to the third embodiment is the same as that according to the above-described first embodiment.

As for a printing process performed by the image forming apparatus 600 in which the user specifies a sheet feed tray based on the tray information, the user displays the tray information reported from the image forming apparatus 600 on a display unit of the information processing apparatus 100 and recognizes the sheet size and the sheet type of sheets placed in each tray (step C1).

The user who checks the displayed tray information and wants to use an out-of-search tray (with the tray lock on) as a sheet feed tray (step C2/Yes) specifies the out-of-search tray (with the tray lock on) as a sheet feed tray based on the displayed tray information (step C3). The information processing apparatus 100 sends a control command to the image forming apparatus 600 to perform printing using the user-specified tray.

When receiving the control command from the information processing apparatus 100, the image forming apparatus 600 performs control according to the control command so that printing is performed using the user-specified tray even when the user-specified tray is set to be out of search (with the tray lock on).

Therefore, the user is able to perform printing by the image forming apparatus 600 using the out-of-search tray (with the tray lock on).

Also, the user who does not use the out-of-search tray (with the tray lock on) (step C2/No) does not specify a tray. In this case, the information processing apparatus 100 sends a control command to the image forming apparatus 600 to perform printing by performing the tray search process, i.e., the processing from step S2 to S11 illustrated in FIG. 5 (step C4).

When receiving the control command from the information processing apparatus 100, the image forming apparatus 600 performs control according to the control command so that printing is performed by performing the tray search process.

Therefore, the user is able to perform printing by the image forming apparatus 600 using a tray determined by the tray search process.

It should be noted that the present invention is not limited to each of the above-described embodiments. As can be understood by those skilled in the art, numerous additional modifications and variations are possible in light of the above teachings. It is therefore to be understood that within the scope of the appended claims, the disclosure of this patent specification may be practiced otherwise than as specifically described herein.

For example, in the above-described embodiments, upon determining that the tray information except that of the manual feed tray is not null, the tray searching unit 109 acquires the tray information except that of the manual feed tray and reports the acquired tray information to the information processing apparatus 100. Alternatively, however, the tray searching unit 109 can be configured to acquire the tray information of the manual feed tray and report the acquired tray information of the manual feed tray to the information processing apparatus 100 as well as the tray information except that of the manual feed tray.

The control operation performed in each apparatus included in the image forming system according to each of the above-described embodiments can be implemented by either hardware or software or a combination of both.

Software processing can be performed by installing a program storing a processing sequence in a memory in a dedicated hard-wired computer and executing the program, or installing the program in a general purpose computer that performs a variety of processes and executing the program.

For example, the program can be previously stored in a storage medium such as a hard disk or a ROM (Read Only Memory). Alternatively, the program can be stored temporarily or permanently in a removable storage medium such as a floppy disk (trademark), CD-ROM (Compact Disk Read Only Memory), MO (Magneto Optical) disk, DVD (Digital Versatile Disk), magnetic disk, and semiconductor memory. Such a removable storage medium can be provided in the form of package software.

The program stored in the above described removal storage medium can be installed in the computer. Alternatively, the program can be wirelessly transmitted from a download site to the computer or can be transmitted to the computer in a wired way via a network such as a LAN (Local Area Network) or internet. The computer receives the transmitted program, which can then be installed in a storage medium such as a built-in hard disk.

In addition, the program can be configured to be performed both in a chronological order according to the processes described in each of the above embodiments and in parallel or individually, as necessary or depending on the capability of the device that performs the processes.

The image forming system described in each of the embodiments can be a logical grouping of a plurality of devices. Alternatively, the devices included in the image forming system can be included in a single housing.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program or computer program product. For example, the aforementioned methods may be embodied in the form of a system or device, including, but not limited to, any of the structures for performing the methodology illustrated in the drawings.

Any of the aforementioned methods may be embodied in the form of a program. The program may be stored on a computer-readable medium and adapted to perform any one of the aforementioned methods when run on a computer device (a device including a processor). The program may include computer-executable instructions for carrying out one or more of the steps above, and/or one or more of the aspects of the invention. Thus, the storage medium or computer-readable medium is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetic storage media, including but not limited to floppy disks (trademark), cassette tapes, and removable hard disks; media with a built-in rewriteable non-volatile memory, including but not limited to memory cards; and media with a built-in ROM, including but not limited to ROM cassettes, etc. Furthermore, various information regarding stored images, for example, property information, may be stored in any other form, or provided in other ways.

Example embodiments being thus described, it will be apparent that the same may be varied in many ways. Such variations are not to be regarded as a departure from the spirit and scope of the present invention, and all such modifications as would be obvious to one skilled in the art are intended to be included within the scope of the following claims.

What is claimed is:

1. An image forming apparatus comprising:
at least one tray;
a manual feed tray;
a setting unit configured to set the at least one tray and the manual feed tray to be out of search;
an acquiring unit configured to acquire tray information of the at least one tray when the at least one tray is set to be subject to the search and of the manual feed tray irrespective of whether the manual feed tray is set to be out of search upon receipt of an acquisition request from a request source; and
a reporting unit configured to report the tray information to the request source.

2. The image forming apparatus according to claim 1,
wherein the acquiring unit acquires the tray, information of the manual feed tray when the tray information of the at least one tray is null.

3. The image forming apparatus according to claim 1,
wherein a setting of being out of search is cancelled for the manual feed tray when the acquiring unit acquires the tray information of the manual feed tray.

4. The image forming apparatus according to claim 1,
wherein the manual feed tray is used for printing irrespective of whether the manual feed tray is set to be out of search.

5. An image forming system comprising:
an information processing apparatus; and
an image forming apparatus comprising at least one tray and a manual feed tray installed therein,
the information processing apparatus configured to report an acquisition request to the image forming apparatus to acquire tray information,
the image forming apparatus comprising:
a setting unit configured to set the at least one tray and the manual feed tray to be out of search;
an acquiring unit configured to acquire tray information of the at least one tray when the at least one tray is set to be subject to the search and of the manual feed tray irrespective of whether the manual feed tray is set to be out of search upon receipt of the acquisition request from the information processing apparatus; and
a reporting unit configured to report the tray information to the information processing apparatus.

6. A control method for an image forming apparatus comprising at least one tray and a manual feed tray installed therein, the control method comprising:
selecting whether or not to set the at least one tray and the manual feed tray to be out of search;
acquiring tray information of the at least one tray when the at least one tray is set to be subject to the search and of the manual feed tray irrespective of whether the manual feed tray is set to be out of search upon receipt of an acquisition request from a request source; and
reporting the tray information to the request source.

7. The control method according to claim 6,
wherein the tray information of the manual feed tray is acquired when the tray information of the at least one tray is null.

8. The control method according to claim 6,
wherein a setting of being out of search is cancelled for the manual feed tray when the tray information of the manual feed tray is acquired.

9. The control method according to claim 6, further comprising:
performing printing using the manual feed tray irrespective of whether the manual feed tray is set to be out of search.
